(19) United States
(12) Patent Application Publication
(10) Pub. No.: US 2011/0051067 A1
(43) Pub. Date: Mar. 3, 2011

(54) LIQUID CRYSTAL DISPLAY DEVICE AND PRINTING PLATE FOR ORIENTATION FILM

(76) Inventor: Tomoyuki SHIROMOTO, Chiba (JP)

(21) Appl. No.: 12/871,490

(22) Filed: Aug. 30, 2010

(30) Foreign Application Priority Data
Aug. 31, 2009 (JP) 2009-199140

(51) Int. Cl. G02F 1/1343; B41F 13/10

(52) U.S. Cl. 349/139; 101/375

(57) ABSTRACT

The orientation film printing pattern of a liquid crystal display panel includes a rectangular shape which adopts apexes of the respective corner portions as apexes thereof as a first rectangular shape and a rectangular shape which is constituted of a pair of short sides and a pair of long sides as a second rectangular shape. The second rectangular shape is arranged within the first rectangular shape, and assuming a length in a short-side direction between an apex of each corner portion and a connection point between one side of each corner portion on the short side and the short side as L1, and assuming a length in a long-side direction between the apex of each corner portion and the connection point between one side of each corner portion on the long side and the long side as L2, the relationship of L1<L2 is satisfied.

### CLAIM OF PRIORITY

The present application claims priority from Japanese application serial No. 2009-199140 filed on Aug. 31, 2009, the content of which is hereby incorporated by reference into this application.

### BACKGROUND OF THE INVENTION

The present invention relates to a liquid crystal display device and a printing plate for an orientation film, and more particularly to a technique which is effectively applicable to a liquid crystal display panel having a narrow picture frame.

As has been well-known, a liquid crystal display panel has a liquid crystal layer between a pair of substrates consisting of a first substrate and a second substrate in a sandwiched manner, and a first orientation film and a second orientation film are formed on both surfaces of the liquid crystal layer respectively (see JP-A-5-257142 (patent document 1)).

These orientation films are formed by an ink-jet method or a flexography method. In a miniaturized liquid crystal display panel, the orientation films are formed by flexography method.

FIG. 10 is a view for explaining an orientation film forming method by a conventional flexography method.

In the orientation film forming method by the conventional flexography method, an orientation film liquid 105 is uniformly applied to an anilox roll 104 by a doctor blade 103, the orientation film liquid 105 applied to the anilox roll 104 is transferred to an orientation film printing plate 102 arranged on a printing drum 100, and the orientation film liquid 105 is applied to an orientation film printing pattern 106 formed on the orientation film printing plate 102.

Then, by printing an orientation film 101 on a substrate SUB using the orientation film printing pattern 106 to which the orientation film liquid 105 is applied, the orientation film 101 is formed on the substrate SUB.

### SUMMARY OF THE INVENTION

In the orientation film forming method by the conventional flexography method, as shown in FIG. 7, a pattern shape of the orientation film printing pattern 106 of the orientation film printing plate 102 has a quadrangular shape (rectangular shape or square shape), while a shape of an orientation film after printing using the orientation film printing plate becomes a shape shown in FIG. 8 where a center portion on each side of the orientation film bulges.

Accordingly, when the distance 1C (printing size) from a center portion of each side of an effective display region 1A to an edge of an orientation film 1B becomes smaller than 0.3 mm, a state where the orientation film is not applied to a corner portion 1D of the effective display region 1A arises thus giving rise to a drawback that narrowing of a picture frame of a liquid crystal display panel becomes difficult.

The invention has been made to overcome the above-mentioned drawback of the related art, and it is an object of the invention to provide a technique which can realize narrowing of a picture frame of a liquid crystal display panel by forming an orientation film having an approximately rectangular shape by optimizing a shape of an orientation film printing pattern of an orientation film printing plate.

The above-mentioned and other objects and novel technical features of the invention will become apparent from the description of this specification and attached drawings.

To briefly explain the summary of typical inventions among inventions disclosed in this specification, they are as follows.

According to one aspect of the invention, there is provided an orientation film printing plate on which an orientation film printing pattern for forming an orientation film provided to a liquid crystal display panel by a flexography method is formed, the orientation film printing pattern including: a pair of straight-line first sides which face each other in an opposed manner; a pair of straight-line second sides which face each other in an opposed manner; and four corner portions which are provided to intersecting portions of the short sides and the long sides, wherein assuming a rectangular shape which adopts apexes of the respective corner portions as apexes thereof as a first rectangular shape and a rectangular shape which is constituted of a pair of first sides and a pair of second sides as a second rectangular shape, the second rectangular shape is arranged within the first rectangular shape.

According to the invention, the pair of straight-line first sides which face each other in an opposed manner and the pair of straight-line second sides which face each other in an opposed manner are the pair of straight-line short sides which face each other in an opposed manner and the pair of straight-line long sides which face each other in an opposed manner. Assuming a length in a short-side direction between an apex of each corner portion and a connection point between one side of each corner portion on the short side and the short side as L1, and assuming a length in a long-side direction between the apex of each corner portion and the connection point between one side of each corner portion on the long side and the long side as L2, the relationship of L1<L2 is satisfied.

Further, according to the invention, assuming a length in a long-side direction between the apex of each corner portion and the connection point between one side of each corner portion on the short side and the short side as L3, and assuming a length in a short-side direction between the apex of each corner portion and the connection point between one side of each corner portion on the long side and the long side as L4, the relationship of L3<L4 is satisfied.

Accordingly, in a liquid crystal display device which forms the orientation film by a flexography method using the orientation film printing plate of the invention, it is possible to set the difference between a maximum value and a minimum value of a distance between one side of the orientation film and an outer peripheral portion of an effective display region which faces one side of the orientation film in an opposed manner to not more than 0.1 mm.

To briefly explain advantageous effects acquired by the typical inventions among the inventions described in this specification, they are as follows.

According to the invention, it is possible to realize the narrowing of a picture frame of a liquid crystal display panel by forming an approximately rectangular orientation film by optimizing the orientation film printing pattern of the orientation film printing plate.

### BRIEF DESCRIPTION OF THE DRAWINGS

FIG. 1 is a cross-sectional view of an essential part showing the schematic cross-sectional structure of a liquid crystal display panel which becomes a premise of the invention;

FIG. 2 is a view showing an orientation film printing pattern of an orientation film printing plate according to an embodiment of the invention which is used in forming an orientation film by printing using a flexography method;

FIG. 3 is a view showing a shape of an orientation film after printing using the orientation film printing plate according to the embodiment of the invention;

FIG. 4 is a graph showing a printing size of the orientation film formed by the orientation film printing plate according to the embodiment of the invention;

FIG. 5A and FIG. 5B are views for explaining the orientation film printing pattern of the orientation film printing plate according to the embodiment of the invention in detail;

FIG. 6 is a view showing another example of a shape of the orientation film after printing using the orientation film printing plate according to the embodiment of the invention;

FIG. 7 is a view showing a conventional orientation film printing plate used in forming an orientation film by printing using a flexography method;

FIG. 8 is a view showing a shape of an orientation film after printing using the conventional orientation film printing plate;

FIG. 9 is a graph showing a printing size of the orientation film formed by the conventional orientation film printing plate; and

FIG. 10 is a view for explaining a conventional orientation film forming method using a flexography method.

### DETAILED DESCRIPTION OF THE INVENTION

An embodiment of the invention is explained in detail hereinafter in conjunction with drawings.

In all drawings for explaining the embodiment, parts having the identical functions are given same symbols and their repeated explanation is omitted.

### [Structure of Liquid Crystal Display Panel]

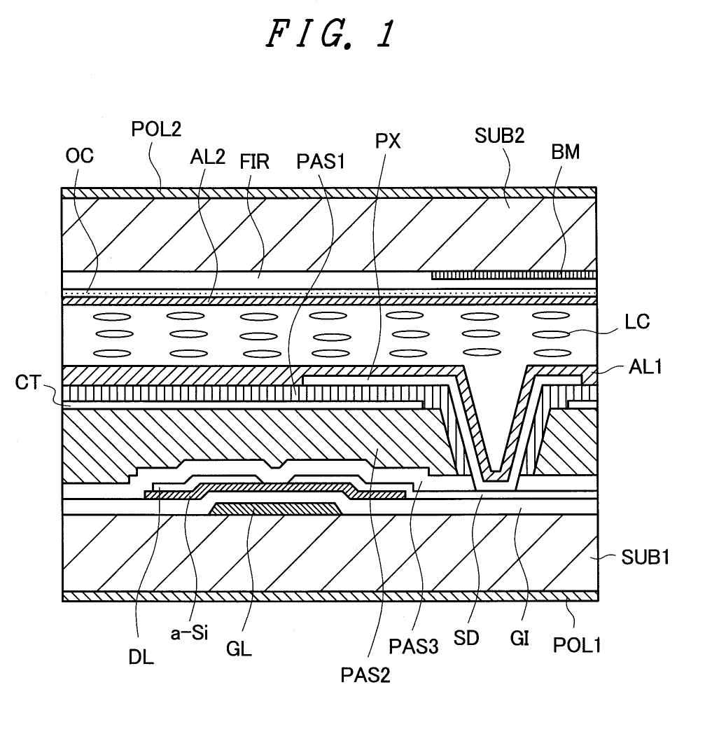

FIG. 1 is a cross-sectional view of an essential part showing the schematic cross-sectional structure of a liquid crystal display panel which becomes the premise of the invention.

In the liquid crystal display panel which becomes the premise of the invention, a first substrate (SUB1; also being referred to as a TFT substrate) and a second substrate (SUB2; also being referred to as a CF substrate) are provided with a liquid crystal layer (LC) sandwiched therebetween. In the liquid crystal display panel shown in FIG. 1, a main surface side of the second substrate (SUB2) constitutes a viewing side.

As shown in FIG. 1, on a liquid crystal layer side of the first substrate (SUB1), in order from the first substrate (SUB1) to the liquid crystal layer (LC), scanning lines (also referred to as gate lines) (GL), a gate insulation film (GI), semiconductor layers (a-Si), video lines (also referred to as drain lines) (DL), conductive layers (SD) which function as source electrodes, an interlayer insulation film (PASS), an interlayer insulation film (PAS2), counter electrodes (CT; also referred to as common electrodes), an interlayer insulation film (PAS1), pixel electrodes (PX), and a first orientation film (AL1) are formed. A first polarizer (POL1) is arranged on an outer side of the first substrate (SUB1).

Further, a thin film transistor (TFT) is constituted of a portion (gate electrode) of the scanning line (GL), the gate insulation film (GI), the semiconductor layer (a-Si), a portion (drain electrode) of the video line (DL), and the conductive layer (source electrode) (SD).

On a liquid crystal layer side of the second substrate (SUB2), in order from the second substrate (SUB2) to the liquid crystal layer (LC), a black matrix (light blocking film) (BM), color filters (FIR) of red, green and blue, a leveling film (OC), and a second orientation film (AL2) are formed. A second polarizer (POL2) is arranged on an outer side of the second substrate (SUB2).

Further, in the liquid crystal display panel shown in FIG. 1, the counter electrode (CT) is formed in a planar shape, and the pixel electrode (PX) is formed of an electrode having a plurality of slits.

As shown in FIG. 1, in the liquid crystal display panel, on both sides of the liquid crystal layer (LC), the first orientation film (AL1) and the second orientation film (AL2) are formed. The first orientation film (AL1) and the second orientation film (AL2) are formed by printing using a flexography method.

Conventionally, printing is applied to the substrate (SUB) having a plurality of orientation film printing regions using an orientation film printing plate having an orientation film printing pattern 20 shown in FIG. 7 thus forming the orientation films (AL1, AL2) on the plurality of orientation film printing regions.

As shown in FIG. 7, the orientation film printing pattern 20 of the conventional orientation film printing plate has a quadrangular shape (rectangular shape or square shape), and a shape of an orientation film after printing using the orientation film printing pattern 20 becomes a shape shown in FIG. 8 where a center portion of each side bulges.

Accordingly, when the distance 1C (printing size) from the center portion of each side of the effective display region 1A to an outer peripheral edge of the orientation film 1B becomes smaller than 0.3 mm, there arises a state where the orientation film is not applied to a corner portion 1D of the effective display region.

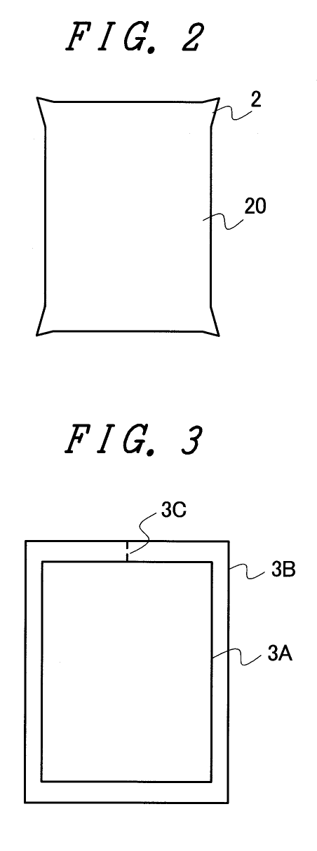

FIG. 2 shows an orientation film printing pattern of an orientation film printing plate according to this embodiment which is used in forming the orientation film by printing using a flexography method.

In this embodiment, for enlarging corner portions of a shape of the orientation film formed after printing by a flexography method, as shown in FIG. 2, the corner portion 2 of the orientation film printing pattern 20 of the orientation film printing plate is formed in a convex shape. As a result, the shape of the orientation film after printing can be brought into a shape which approximates a quadrangular shape (rectangular shape or square shape) as shown in FIG. 3.

Accordingly, even when the distance 3C (hereinafter referred to as printing size) from the center portion of each side on the outer periphery of the effective display region 3A to one side of the orientation film 3B is not more than 0.3 mm, it is possible to apply the orientation film 3B to the corner portions of the effective display region 3A.

Accordingly, in this embodiment, the difference between a maximum value and a minimum value of the distance between one side of the orientation film 3B and the outer peripheral portion of the effective display region 3A which faces one side of the orientation film 3B in an opposed manner can be set to not more than 0.1 mm. A thickness of the orientation film 3B is set to several 10 to several 100 nm.

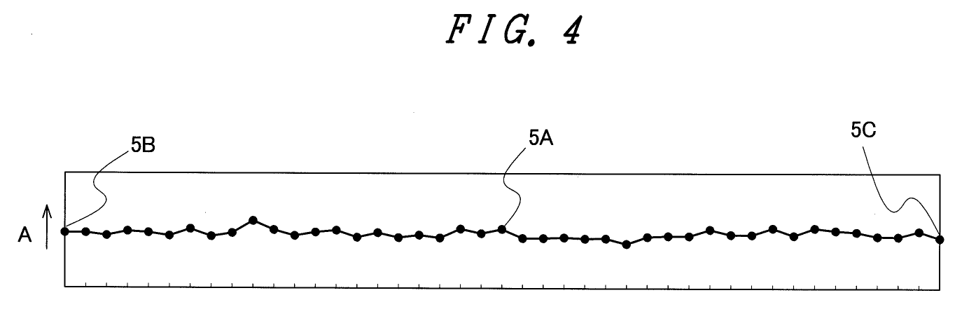

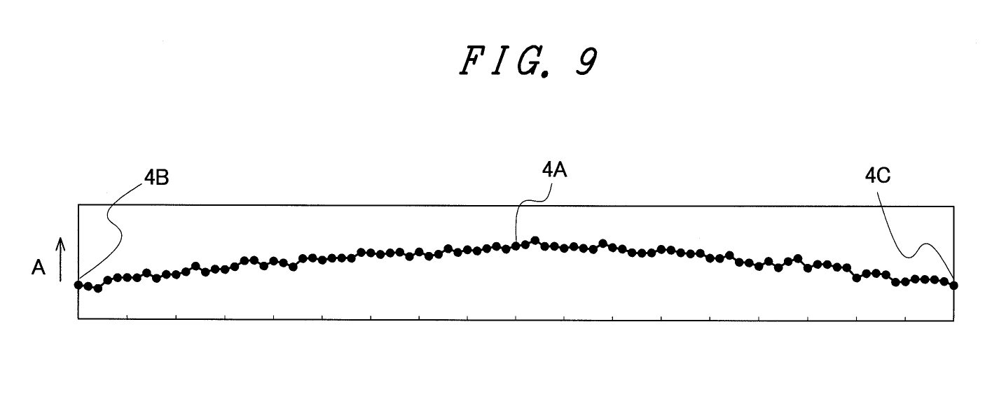

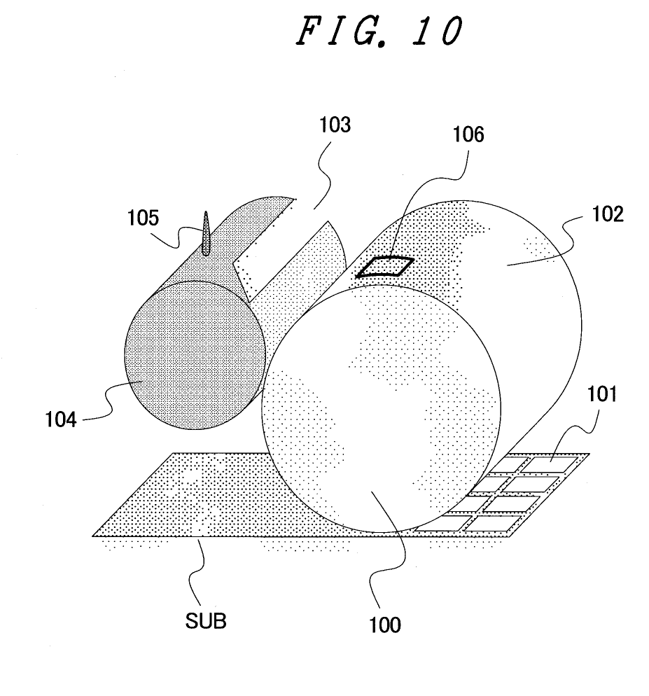

FIG. 4 is a graph showing a printing size (A) of an orientation film 3B formed by an orientation film printing plate 20 of this embodiment, and FIG. 9 is a graph showing a printing size of an orientation film 3B formed by a conventional orientation film printing plate 20. That is, FIG. 4 and FIG. 9 are graphs showing distance from respective portions on each side of an effective display region to an outer peripheral edge of the orientation film.

In the orientation film 1B formed by the conventional orientation film printing plate 20, as shown in FIG. 9, a printing size at a center portion 4A of an outer periphery of an effective display region 1A is larger than a printing size at corner portions (4B, 4C) and hence, the center portion exhibits a bulged shape.

On the other hand, in the orientation film 3B formed by the orientation film printing plate 20 of this embodiment, as shown in FIG. 4, a printing size at a center portion 5A of an effective display region 3A is approximately equal to a printing size at corner portions (5B, 5C) and hence, a shape of the orientation film after printing approximates a rectangular shape (or a square shape). In this embodiment, it is understood that the difference between a maximum value and a minimum value of a distance between one side of the orientation film 3B and the outer peripheral portion of the effective display region 3A which faces one side of the orientation film 3B in an opposed manner is set to not more than 0.1 mm.

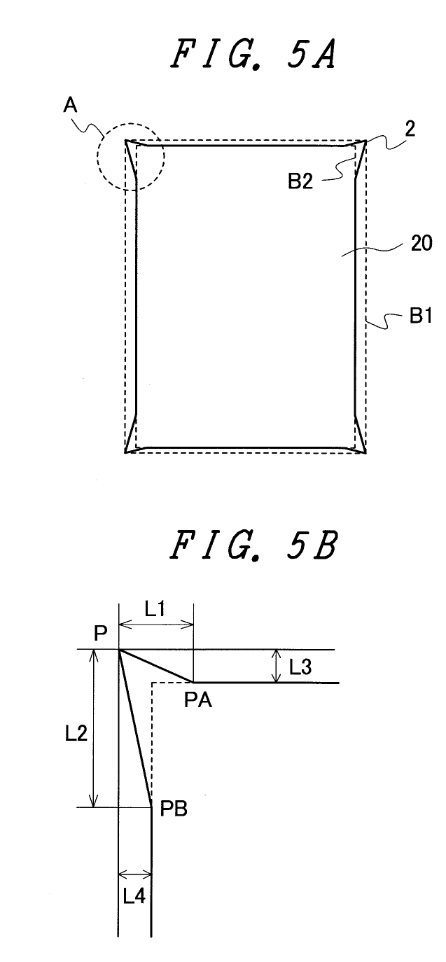

FIG. 5A and FIG. 5B are views for explaining the orientation film printing pattern 20 of the orientation film printing plate according to this embodiment in detail.

As shown in FIG. 5A, the orientation film printing pattern of the orientation film printing plate according to this embodiment includes one pair of straight short sides which face each other in an opposed manner, one pair of straight long sides which face each other in an opposed manner, and four corner portions 2 which are formed at intersecting portions between the short sides and the long sides. Here, assuming a rectangular shape which adopts apexes of respective corner portions 2 as apexes thereof as a first rectangular shape (B1 in FIG. 5A) and a rectangular shape which is constituted of a pair of short sides and a pair of long sides as a second rectangular shape (B2 in FIG. 5A), the second rectangular shape is arranged within the first rectangular shape.

Further, FIG. 5B is a view showing a part A in FIG. 5A in an enlarged manner. As shown in FIG. 5B, assuming a length in the short-side direction between an apex (P) of the corner portion 2 and a connection point (PA) between one side of the corner portion 2 on the short side and the short side as L1, and assuming a length in the long-side direction between the apex (P) of the corner portion 2 and a connection point (PB) between one side of the corner portion 2 on the long side and the long side as L2, the relationship of L1<L2 is satisfied in this embodiment.

Further, assuming a length in the long-side direction between the apex (P) of the corner portion 2 and the connection point (PA) between one side of the corner portion 2 on the short side and the short side as L3, and assuming a length in the short-side direction between the apex (P) of the corner portion 2 and the connection point (PB) between one side of the corner portion 2 on the long side and the long side as L4, the relationship of L3<L4 is satisfied. Here, optimum values of L1 to L4 differ for every size of a liquid crystal display panel and hence, it is necessary to suitably set the lengths L1 to L4 in accordance with a size of the liquid crystal display panel.

Further, although one side of the corner portion 2 on the short side and one side of the corner portion 2 on the long side are formed into a straight-line shape, one side of the corner portion 2 on the short side and one side of the corner portion 2 on the long side may have a curved shape.

The shape of the orientation film after printing by an orientation film forming method which adopts a conventional flexography method is formed into a shape shown in FIG. 8 where a center portion of each side of the orientation film bulges. Accordingly, there has been known a technique where a convex portion is formed on an outer side of the orientation film so as to attenuate the tendency that the center portion of each side of the orientation film after printing is formed into a bulging shape.

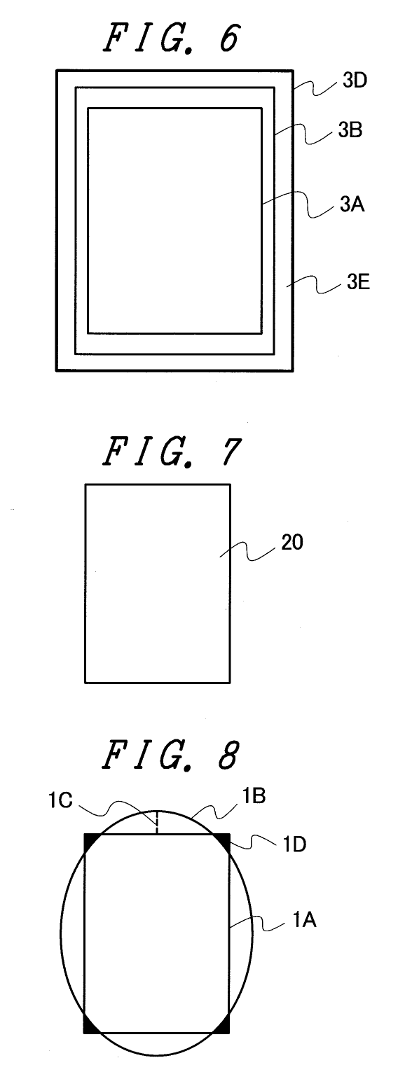

Also in this embodiment, as shown in FIG. 6, even when a convex portion 3D is formed on an outer side of the orientation film, it is possible to prevent the orientation film after printing from being formed into a shape where the center portion of each side of the orientation film bulges. Accordingly, a gap 3E is formed between one side of the orientation film 3B and the convex portion 3D.

Although the invention made by inventors of the invention has been specifically explained in conjunction with the embodiment heretofore, it is needless to say that the invention is not limited to the above-mentioned embodiment and various modifications are conceivable without departing from the gist of the invention.

What is claimed is:

1. A liquid crystal display device comprising:
a liquid crystal layer which is sandwiched between a pair of substrates; and
orientation films which are arranged with the liquid crystal layer sandwiched therebetween, wherein
the difference between a maximum value and a minimum value of a distance between one side of the orientation film and an outer peripheral portion of an effective display region which faces one side of the orientation film in an opposed manner is set to not more than 0.1 mm.

2. The liquid crystal display device according to claim 1, wherein a convex portion is formed on an outer side of the orientation film, and
a gap is formed between the one side of the orientation film and the convex portion.

3. The liquid crystal display device according to claim 2, wherein the orientation film is formed by a flexography method.

4. The liquid crystal display device according to claim 1, wherein a thickness of the orientation film is set to several 10 nm to several 100 nm.

5. An orientation film printing plate on which an orientation film printing pattern for forming an orientation film provided to a liquid crystal display panel by a flexography method is formed, the orientation film printing pattern comprising:
a pair of straight-line first sides which faces each other in an opposed manner;
a pair of straight-line second sides which faces each other in an opposed manner; and
four corner portions which are provided to intersecting portions of the short sides and the long sides, wherein
assuming a rectangular shape which adopts apexes of the respective corner portions as apexes thereof as a first rectangular shape and a rectangular shape which is constituted of a pair of first sides and a pair of second sides as a second rectangular shape, the second rectangular shape is arranged within the first rectangular shape.

6. An orientation film printing plate on which an orientation film printing pattern for forming an orientation film provided to a liquid crystal display panel by a flexography method is formed, the orientation film printing pattern comprising:
a pair of straight-line short sides which faces each other in an opposed manner;
a pair of straight-line long sides which faces each other in an opposed manner; and
four corner portions which are provided to intersecting portions of the short sides and the long sides, wherein
assuming a rectangular shape which adopts apexes of the respective corner portions as apexes thereof as a first rectangular shape and a rectangular shape which is constituted of a pair of first sides and a pair of second sides as a second rectangular shape, the second rectangular shape is arranged within the first rectangular shape, and
assuming a length in a short-side direction between an apex of the each corner portion and a connection point between one side of the each corner portion on the short side and the short side as L1, and assuming a length in a long-side direction between the apex of the each corner portion and the connection point between one side of the each corner portion on the long side and the long side as L2, the relationship of L1<L2 is satisfied.

7. The orientation film printing plate according to claim 6, wherein assuming a length in a long-side direction between the apex of the each corner portion and the connection point between one side of the each corner portion on the short side and the short side as L3, and assuming a length in a short-side direction between the apex of the each corner portion and the connection point between one side of the each corner portion on the long side and the long side as L4, the relationship of L3<L4 is satisfied.

8. The orientation film printing plate according to claim 7, wherein one side of the each corner portion on the short side and one side of the each corner portion on the long side are formed into a straight-line shape.
